(19) United States
(12) Patent Application Publication
(10) Pub. No.: US 2016/0325301 A1
(43) Pub. Date: Nov. 10, 2016

(54) Flexible Watering Hose Attachment

(71) Applicant: James Jenkins, Antioch, CA (US)

(72) Inventor: James Jenkins, Antioch, CA (US)

(21) Appl. No.: 14/850,618

(22) Filed: Sep. 10, 2015

Related U.S. Application Data
(60) Provisional application No. 62/157,442, filed on May 5, 2015.

(51) Int. Cl. B05B 15/06

(52) U.S. Cl. CPC B05B 15/066; B05B 15/061

(57) ABSTRACT

A water hose attachment having a flexible arm which may be articulated in any desired direction and maintain the position without the need for additional support. The arm is made up of multiple segmented rigid couplings in a ball and socket design. This ball and socket tubing allows superior flexibility of the arm such that the user may manipulate the direction of water flow by bending the arm in any direction of his choice.

### PRIORITY

This application claims priority to U.S. provisional application No. 62/157,442, filed on May 5, 2015, which is herein incorporated by reference in this application.

### TECHNICAL FIELD

The present invention relates generally to devices for controlling the flow of water from a hose and, more particularly to improvements in watering hose attachments which can be used for gardening, lawn care, home care, vehicle care and the like.

### BACKGROUND

Watering hose attachments may be used for a variety of purposes, such as for watering plants, lawns and cars. These attachments connect to the male threaded end of a standard garden hose and can include a hand operated rotary valve or a rear lever or trigger mechanism to actuate an internal valve which controls the flow of water through the attachment. Watering hose attachments come in various forms, such as nozzles to provide the desired water spray pattern to fit the particular spray application, rigid extension rods to reach higher elevations, and even trigger guns to allow the user to point and spray water in the area desired. However, a problem often associated with these prior art attachments is that there are corners or areas that are difficult to reach, such as overhead plants, home gutters or the tire area of a vehicle. Such areas require several steps to achieve the appropriate watering, such as removing the attachment and replacing it with a new attachment and/or even using a step stool or ladder. The need for these extra steps and/or manipulation to achieve the desired watering takes time, can be tiring for the user and can be especially difficult for users with chronic pain in the hands and arms, or users with a handicap or disability.

For example, in order to spray water at the appropriate pressure into the tire area of a car, the user must bend down and/or adjust his wrist position in an uncomfortable manner. Additionally, a person in a wheelchair would have problems reaching the top of a vehicle and/or a tall plant from the sitting position. It is therefore desirable to have a flexible hose attachment that overcomes all the aforementioned problems by being bendable and adjustable during use. The attachment would be easy to bend and manipulate by the user and have the capability to be positioned at various angles and lengths to suit the particular spray application. Preferably, the attachment would be constructed of a lightweight material for ease of use, but also have the ability to withstand high pressure and/or turbulent water flow.

### SUMMARY

In one general aspect there is provided a watering hose attachment having a handle with a water inlet located at a proximal end, a water outlet located at a distal end, and a water channel within the handle which connects the inlet and the outlet, an articulating arm having a proximal end which is in connection with the water outlet and a distal end which is mated to a spray nozzle, the articulating arm having a first segment and a second segment, with each segment including a first hollow truncated sphere having an outer surface and an inner surface, a second hollow truncated sphere having an outer surface and an inner surface, a hollow, annular waist section having an outer surface and an inner surface where the first and second hollow truncated spheres are joined together by the annular waist section with the outer surfaces of the first and second hollow truncated spheres merging with the outer surface of the hollow annular waist section and the inner surfaces of the first and second hollow truncated spheres merging with the inner surface of the hollow annular waist section where the radius of curvature of the inner surface of the second hollow truncated sphere is slightly greater than the radius of curvature of the outer surface of the first hollow truncated sphere, such that the first hollow truncated sphere is partially contained within the second hollow truncated sphere.

Embodiments of the watering hose attachment may include one of the following features. It may include an elongate tubular body having a proximal end and a distal end, where the elongate tubular body is mated to the water outlet of the handle at its proximal end and mated with the articulating arm at its distal end.

The first hollow truncated sphere, the second hollow truncated sphere and the annular waist section may form an hour glass configuration.

The first hollow truncated sphere, the second hollow truncated sphere and the annular waist section may be formed as unitary one piece construction.

The first and second segments may be snap fitted together to form a fluid tight connection.

The first and second segments may be made out of a plastic material.

The first and second segments may form a hollow inner water passageway that is substantially free from obstructions.

The articulating arm may be bent to direct the flow of water exiting the nozzle and maintain the bent position without the use of additional support.

The articulating arm may be substantially free from metal.

In another general aspect there is provided a watering hose attachment kit having a handle having a water inlet located at a proximal end, a water outlet located at a distal end, and a water channel within the handle which connects the inlet and the outlet, an articulating arm having a proximal end which is in connection with the water outlet and a distal end which is mated to a spray nozzle, the articulating arm having a first segment and a second segment, with each segment including a first hollow truncated sphere having an outer surface and an inner surface, a second hollow truncated sphere having an outer surface and an inner surface, a hollow, annular waist section having an outer surface and an inner surface, where the first and second hollow truncated spheres are joined together by the annular waist section with the outer surfaces of the first and second hollow truncated spheres merging with the outer surface of the hollow annular waist section and the inner surfaces of the first and second hollow truncated spheres merging with the inner surface of the hollow annular waist section, where the radius of curvature of the inner surface of the second hollow truncated sphere is slightly greater than the radius of curvature of the outer surface of the first hollow truncated sphere, such that the first hollow truncated sphere is partially contained within the second hollow truncated sphere, and a third segment or a plurality of segments separated from the first and second segments which may be used to extend the length of the articulating arm.

### DESCRIPTION OF THE DRAWINGS

FIG. 1 is a side view of the water hose attachment 10.

FIG. 2 is a front view of the water hose attachment 10 showing the head of the attachment in the foreground.

FIG. 3A is a back view of the water hose attachment 10 showing the threaded inlet in the foreground and the head in the background.

FIG. 3B is a perspective view of the handle 11 showing inlet 18.

FIG. 4 is a seal 23 which may be incorporated into many junctions of the water hose attachment.

FIG. 5 is the articulating arm 15 of the water hose attachment.

FIG. 6 is a perspective view of the fitting 24.

FIG. 7 is a perspective view of the handle 11.

FIG. 8 is a perspective view of the rod 13.

FIG. 9 is a perspective view of the cushion 14.

FIG. 10 is a perspective view of the outlet opening 19 of the handle 11.

FIG. 11 is a perspective view of the head 16.

FIG. 12 is a perspective view of the fitting 22 which connects the arm and the rod 13 of the water hose attachment.

FIG. 13 is a view of the internal valve mechanism which controls water flow out of outlet 19 when the handle is pressed.

FIG. 14 is a perspective view of the plunger 31.

FIG. 15 is a perspective view of the spring 33.

FIG. 16 is a view of tube segments 100 a-b.

FIG. 17 is a view of tube segments 100 a-c.

FIG. 18 is a view of tube segments 100 a-b with one of the segments articulated at an angle against the other segment.

### DETAILED DESCRIPTION

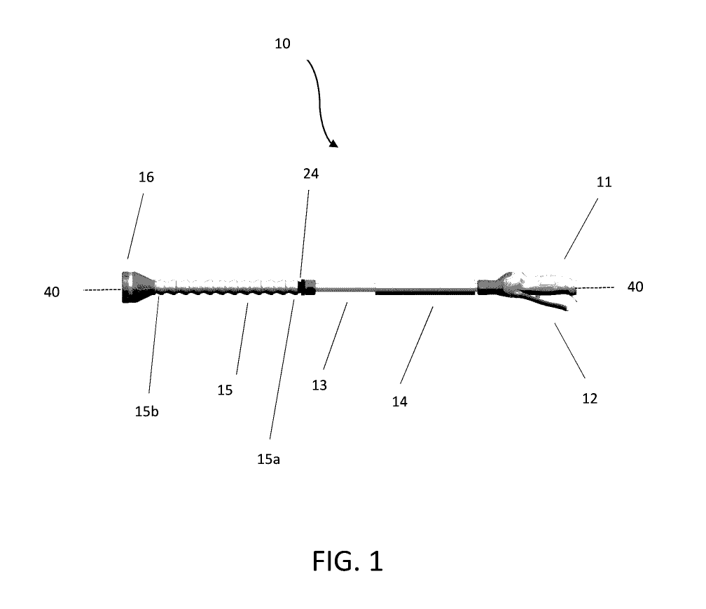

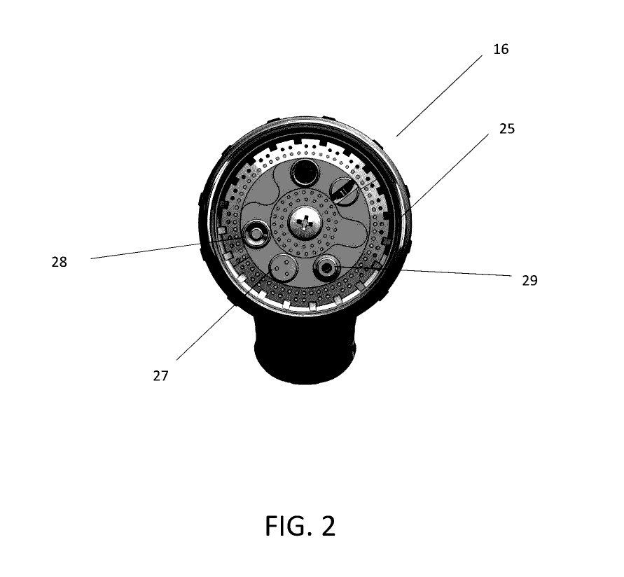

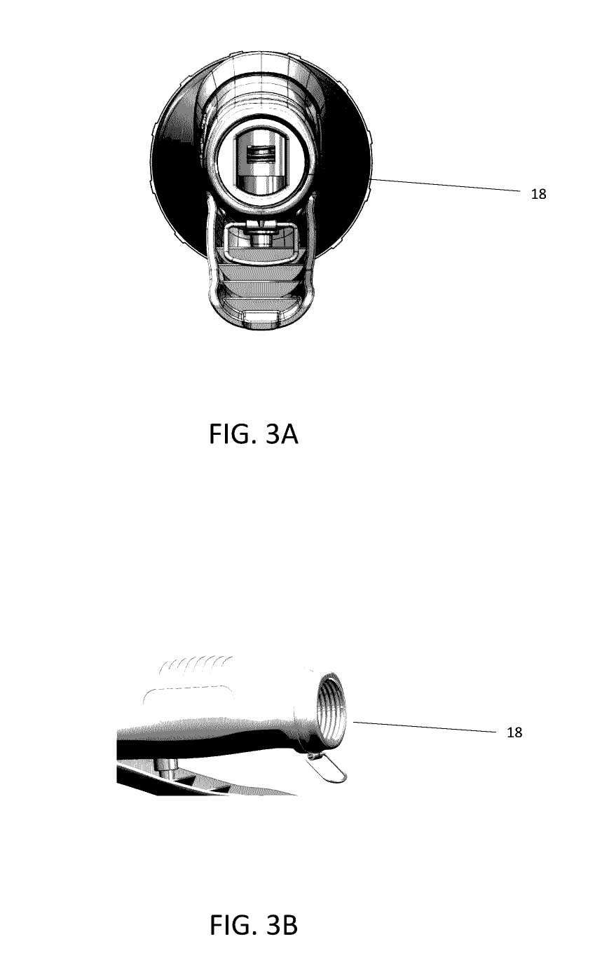

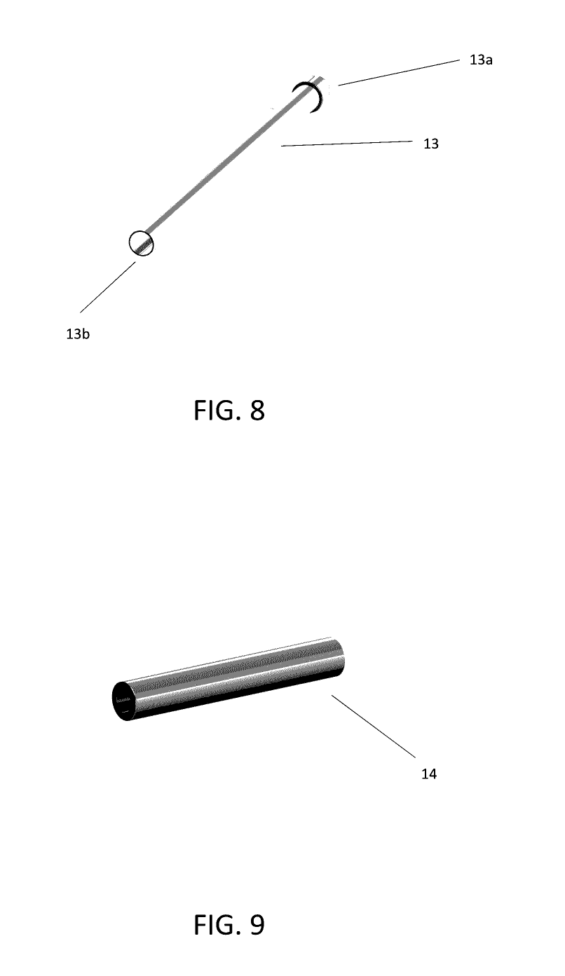

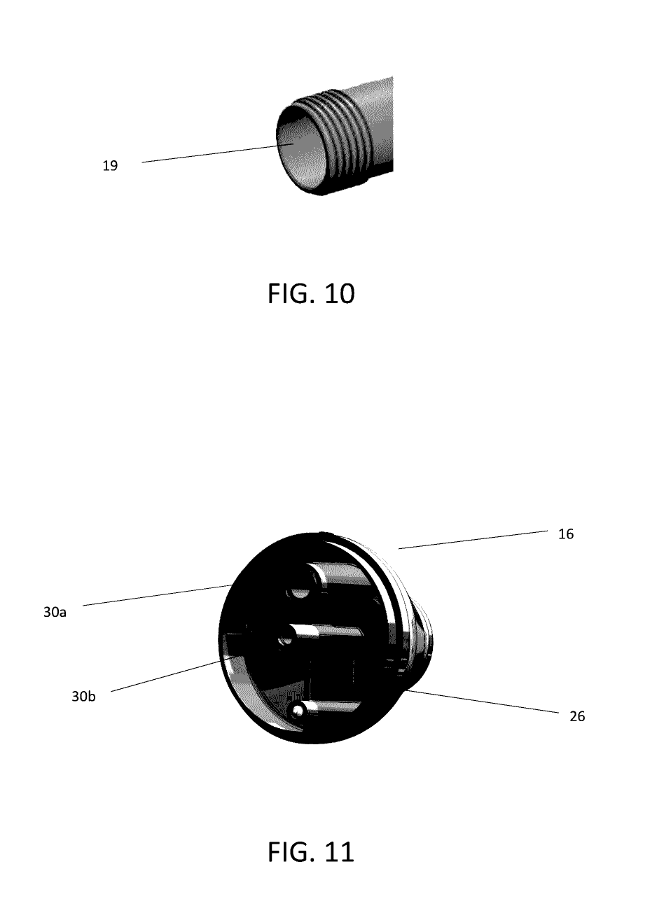

FIG. 1 shows a perspective view of the water hose attachment 10. The water hose attachment is made up of a handle 11, a substantially hollow elongate tubular body or rod 13, cushion 14, arm 15, and head or nozzle 16. The water hose attachment has a proximal end at the handle 11 and a distal end at the head or nozzle 16. The handle 11 may be a trigger grip assembly including a trigger 12 which may be pressed by the user to allow the flow of water through the water hose attachment 10. The handle is shown in more detail in FIG. 7, and includes a water passageway or inlet 18 which is designed to threadably mate with a standard water hose male end such that the inner surface of the inlet is threaded in the conventional manner. The inlet 18 is also shown in FIG. 3 which is a back view of the water hose attachment showing the inlet in the front and the head or nozzle 16 in the background. At the distal end of the handle is opening 19, designed to mate with the hollow tubular body or rod 13 such that when a water source is turned on and the trigger 12 is pressed down by the user, water can flow first through an internal channel of the handle, next through outlet opening 19 and next through hollow rod 13. The hollow rod or tubular body 13 may be attached to the handle by a variety of methods. For example, the hollow rod may be press fitted into the outlet opening 19 and may optionally be secured using adhesive within the inside of the handle around the opening 19 to achieve a secure fit. In another embodiment, the rod and handle may include one or more holes designed to fit a screw, nail or other fastener. In other embodiment, the rod is secured to the handle by a pressure fit. In another embodiment, the rod includes threading on its outside surface and is configured to mate with threading on the inside surface of opening 19 in a conventional manner. The rod or tubular body 13 has a proximal end 13a and a distal end 13b as shown in FIG. 8.

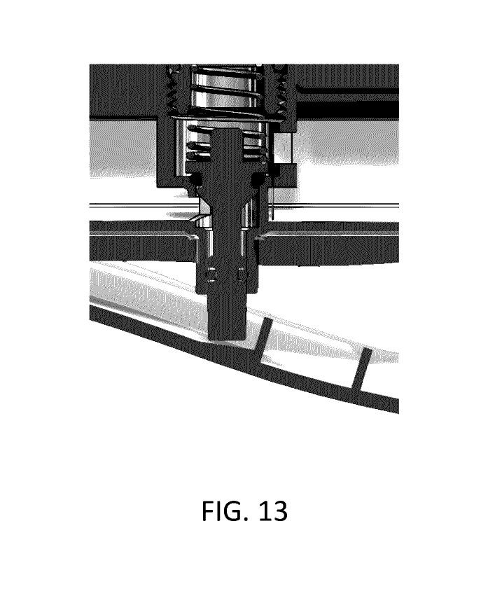

The trigger grip assembly includes an outside housing 20 and a trigger 12, both or either of which may be constructed of a light weight plastic or metal material, such as stainless steel, aluminum or a metal alloy. The outside housing and trigger may include an additional cushion or gel type layer in order to facilitate a comfortable grip for the user. The trigger assembly functions to allow water to flow when the trigger is in the pressed position. This may be performed in a conventional manner such as an internal valve mechanism which blocks the main channel within the handle by which water is meant to flow, shown in FIG. 13. The trigger is designed to be in connection with the internal valve such that when the trigger is pressed, the valve opens either partially or completely to allow the flow of water out of handle outlet 19. Examples of valve mechanisms which may be applied to the trigger grip assembly include U.S. Pat. Nos. 6,702,206 and 5,303,868 which are incorporated herein by reference.

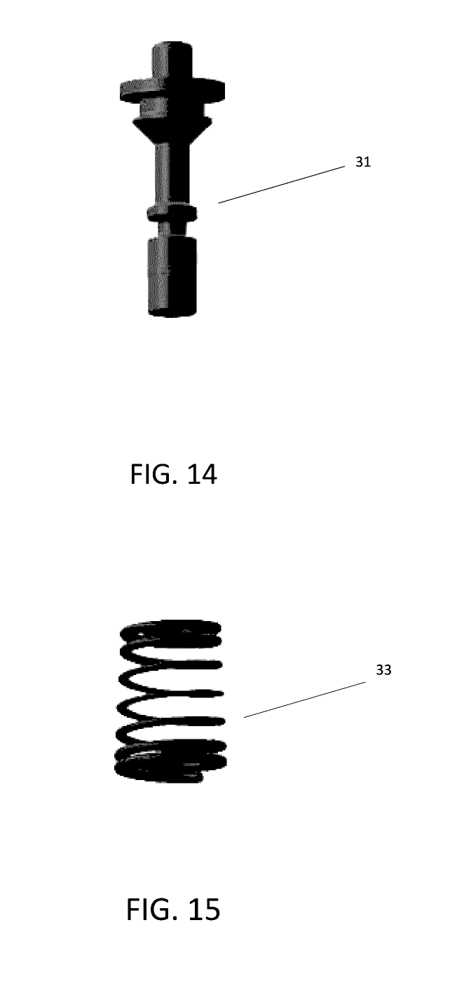

A plunger 31 and spring 33 are shown in FIGS. 14 and 15, respectively, which may be used in conjunction with the trigger grip assembly to allow and restrict the flow of water out of outlet 19.

A variety of different kinds of valves may be used in connection with the trigger grip assembly to give the desired water flow, such as a ball valve, gate valve, butterfly valve, globe valve and the like. A switch 21 may also be included in the trigger grip assembly, which may be used to “lock” the trigger in the pressed position so that the user need not have one hand constantly pressing the trigger down while using the water hose attachment. For example, the user may press down on the trigger to allow the flow of water through the handle outlet 19 and/or the internal channel within the handle and subsequently may engage the switch 21 to keep the trigger in the pressed position. The user may thereafter let go of the trigger while it remains in the pressed position by the use of the switch and use his hand to hold the cushion 14 and/or manipulate the arm 15. Alternatively, the user may simply have his hand free without the need to apply pressure to the trigger to keep it in the pressed position. This provides enhanced versatility of the hose attachment by allowing a hands free method of operating the device.

Cushion 14 may be a tubular member designed to fit around the rod 13. The cushion may be constructed out of a soft material to enable the user to easily hold and manipulate the water hose attachment 10, such as foam, rubber or plastic. The cushion has a length that is about 6 inches to about 18 inches and most preferably from about 8 inches to 15 inches. The cushion may cover the entire length of rod 13 or only a portion of the rod. The rod 13 may be a rigid rod and may be constructed of a rigid lightweight material such as plastic or metal. The rod has a first proximal end which is designed to mate with outlet opening 19 of the handle 11 and a second distal end which is designed to mate with arm 15. The cushion 14 may be permanently secured to the rod or removable by the user. For example, the cushion may be secured using an adhesive applied on the outer surface of the rod. Alternatively, the cushion may be compression fit based on the diameter of the rod 13. The user may move the position of the cushion along the length of the rod in order to achieve the optimal ergonomic placement of the cushion.

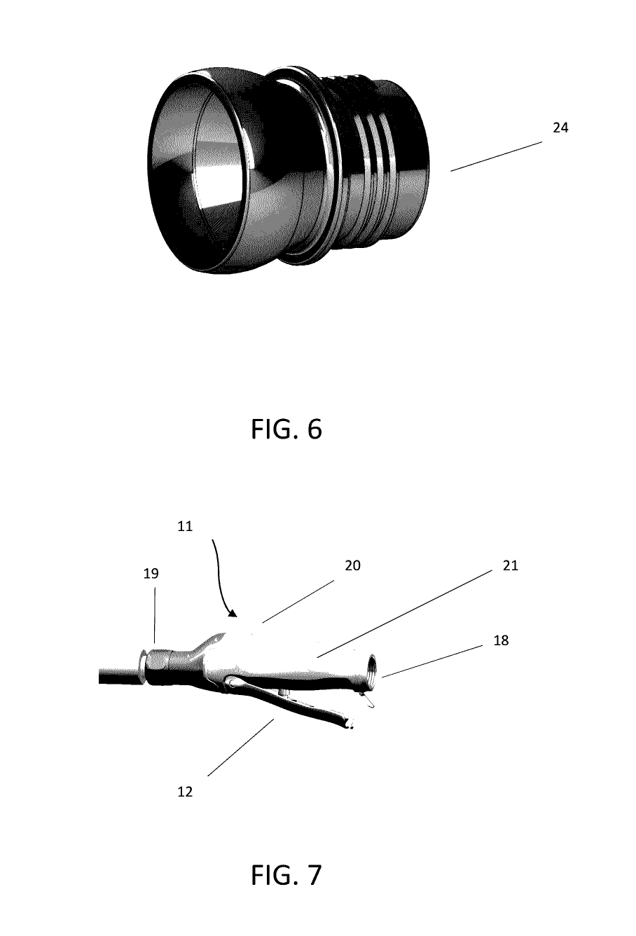

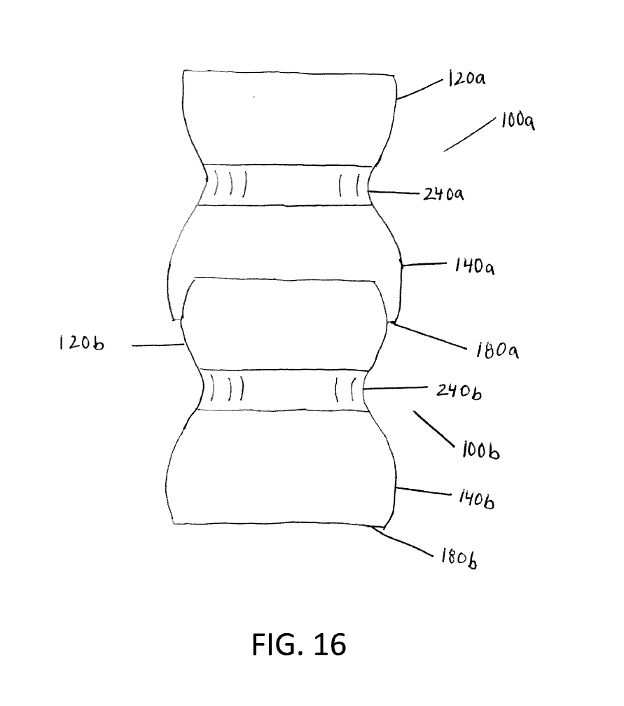

Secured to the distal end of the rod is pipe fitting 24 (shown in detail in FIG. 6) designed to mate with rod 13. Pipe fitting 24 is shown in more detail in FIG. 6, with one end being threaded on its inside surface to mate with the outside threading of the rod 13, or one end could be threaded on its outside surface to mate with the inside threading of rod 13. The other end of the pipe fitting 24 may also be threaded on its outside surface and configured to mate with ball and socket arm 15. Arm 15 is a flexible arm which may be articulated in any desired direction and maintain the position without the need for additional support. The arm is made up of multiple rotatable segmented rigid couplings in a ball and socket design. This ball and socket tubing allows superior flexibility of the arm such that the user may manipulate the direction of water flow by bending the arm in any direction of his choice. The tube segments are illustrated in FIGS. 16-18. Tube segments 100a-c are preferably identical in construction and design and are shown in an hour glass configuration. Tube segment 100a includes an upper truncated sphere or bulbous end portion 120a, a lower truncated sphere or bulbous end portion 140a, and an annular intersection or narrow, hollow, annular waist section or narrowed mid section 240a, all of uniform and identical wall thickness. The upper truncated sphere or bulbous end portion 120a may have a slightly smaller radius than the lower annular surface or peripheral end edge 180a of the lower truncated sphere or bulbous end portion 140a in order to allow the two pieces to lock, snap or press fit in place.

The smaller truncated sphere or bulbous end portion is designed to fit either partially or completely within the larger truncated sphere or bulbous end portion of a different segment such that the two segments cannot be easily removed from each other. With each successive segment that is attached in this way, the longer the articulating arm will become and the greater degree of flexibility and manipulation is achieved in the articulating arm 15. The three dimensional shape of the individual tube segments is such that the segments can be engaged between the smaller truncated sphere which abuts the larger truncated sphere. This enables the arm to be bent into different stable shapes and positions to achieve the type of watering desired.

The rod or tubular body 13 is substantially straight and is symmetrically disposed along a longitudinal axis 40. The handle is also disposed along longitudinal axis 40. The articulating arm 15 may also be symmetrically disposed along the longitudinal axis 40, however it has the ability to be bent into a multitude of shapes so that it need not be straight. In one embodiment the arm 15 is curved upwards to direct water in this direction. In another embodiment, the arm 15 is curved downwards to direct water in the downward direction. The arm is configured to bend at any angle to the longitudinal axis 40, such as at 30 degrees, 60 degrees or 90 degrees to longitudinal axis 40. In one embodiment, the arm may be transversely bent to the left of axis 40, or to the right, above or below axis 40. The arm may be bent in this manner at various points along the length of the arm.

The segments forming the articulating arm may be attached to one another such that they may be rotated in place, but are designed to create a fluid tight seal. The individual links/segments can be snap fitted together and therefore may be modular and expandable by the user. This is especially preferable when the watering hose attachment is provided in a kit. According to one embodiment, the kit includes the watering hose attachment described above along with extra parts such as extra snap fit rigid segments 100 for the user to control the length of the articulating arm. The kit could also include extra pipe fittings or mating pieces to enable the user to make easy repairs or adjustments to the device with no special tools.

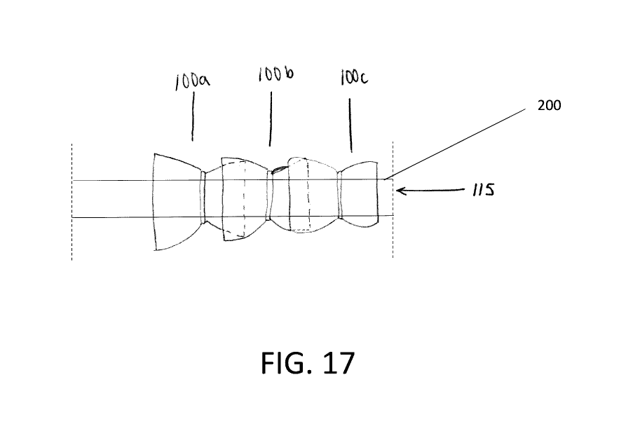

FIG. 17 shows tube segments 100 a, b and c which may be snappably engaged in an end to end fashion, creating unlimited expansion of the articulating arm 15. The ball and socket joints created by the intersection of tube segments 100a-c allow the user to rotationally position the arm in any number of positions. The segments when fitted together form an arm having an internal channel 115 shown in FIG. 17. In one aspect of the invention, the internal surface of the channel is smooth and without substantial interferences to block water flow within the channel. In fact, the presence of any obstructions within the channel which do not make up the surface of the channel is considered undesirable because it could result in inefficient water flow through the internal channel 115. In another embodiment, the internal channel houses a secondary hose 200 which is flexible to ensure no water may leak out of the arm. Hose 200 is shown in FIG. 17 and is dimensioned to fit within the internal channel 115 such that it has a radius that is slightly less than the radius of the internal channel. Hose 200 preferably has a length that is equal to the length of the flexible arm, but it may also be loner or shorter in length.

The annular waist section 24 preferably has a more narrow radius than the radius of the truncated spheres or bulbous end portions. The annular waist section preferably forms an outer concave surface and an inner convex surface such that the overall shape of the segment is an hourglass shape. The shape of the segments should not be construed as limited to this above described shape, however. For example, the waist section may be a substantially tubular shaped portion which may have a radius of from about 5 mm to about 30 mm and a length of from about 0 mm to about 35 mm. The radius of the truncated spheres or bulbous end portions may be from about 6 mm to about 50 mm and the length of the truncated spheres may be from about 5 mm to about 50 mm.

In one aspect of the invention, the articulating arm 15 can be retained in a sleeve as an interference/friction fit or retained therein by optional end plugs/caps.

The arm 15 is preferably made of a plastic material, such as ABS (acrylonitrile butadiene styrene), SAN (styrene acrylonitrile resin), polycarbonate or other appropriate polymer material which is durable and flexible. The material may also be made of a rubber material or metal material, such as a lightweight aluminum. The size of the ball and socket joint may be the same or variable, depending on the intended use of the attachment. For example, the segments 100 a-c could be continually smaller in size from proximal end to distal end, which may aid in building up water pressure within the hose attachment to achieve a high pressure spray. The use of segments having a radius that is smaller than the one located proximal to it may also create a telescoping design which would allow the attachment to be stored easily when not in use.

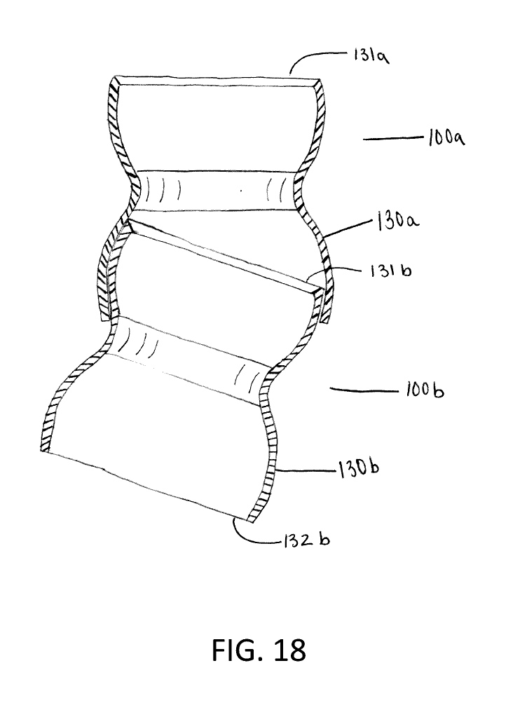

FIG. 18 shows segments 100a and 100b with segment 100b being in a rotated and/or angled position while still keeping a fluid tight communication or seal between the two segments. The segments include a wall 130a and 130b which may be the same thickness along the length of the segment or may change along the length of the segment. A substantially circular opening is apparent at 131a and 131b. Openings 131a and 131b are slightly smaller in diameter than openings 132a and 132b such that the upper truncated sphere or bulbous portion of segment 100b engages and locks in place with lower truncated sphere or bulbous portion of segment 100a to achieve a tight fit.

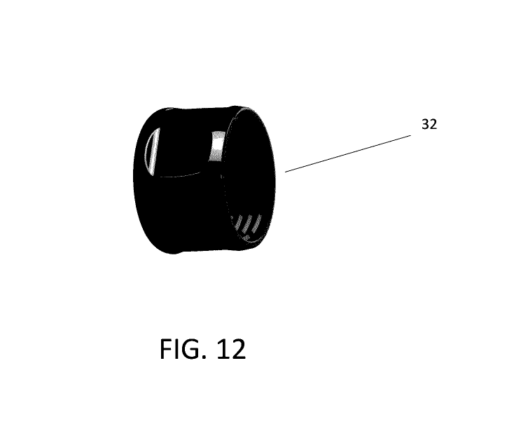

The arm includes a proximal end 15a and a distal end 15b as shown in FIG. 1. The proximal end of the arm is connected to pipe fitting 24 and the distal end of the arm is connected to connector 22, shown in detail in FIG. 12. The outside surface of the arm may be threaded to engage with the inside surface of connector 22. The other end of the connector 22 may be attached to head or nozzle 16 by any means, such as threaded mating, compression fit, using adhesive, or using a screw, nail or other type of fastener. Preferably, the connector is threadably mated with the head or nozzle 16.

Head or nozzle 16 is one of a number of nozzle types which can be used, comprising a tapered outer shell 26, a rotary piece 25 and an optional internal valve mechanism. Rotary piece 25 includes a number of spray outlets 27, 28 and 29 which can be selectively engaged to emit the desired type of spray of water from a concentrated spray to a diffused spray. The rotary piece 25 is fitted to the head 16 as is conventionally done and has the ability to turn 360 degrees. FIG. 11 shows the head or nozzle 16 having one or more head outlets 30a and 30b where water can flow through. As the rotary piece is turned one or more spray outlets 27, 28, and 29 are matched up with the one or more head outlets 30a and 30b to achieve the desired spray pattern. A non-rotary spray nozzle may also be used which emits a single type of spray pattern. Head or nozzle 16 may be screwably connected to an externally threaded portion of the arm 15 by means of mating internal threading of the head or nozzle. The head may also be compression fit to the distal end of the arm 15.

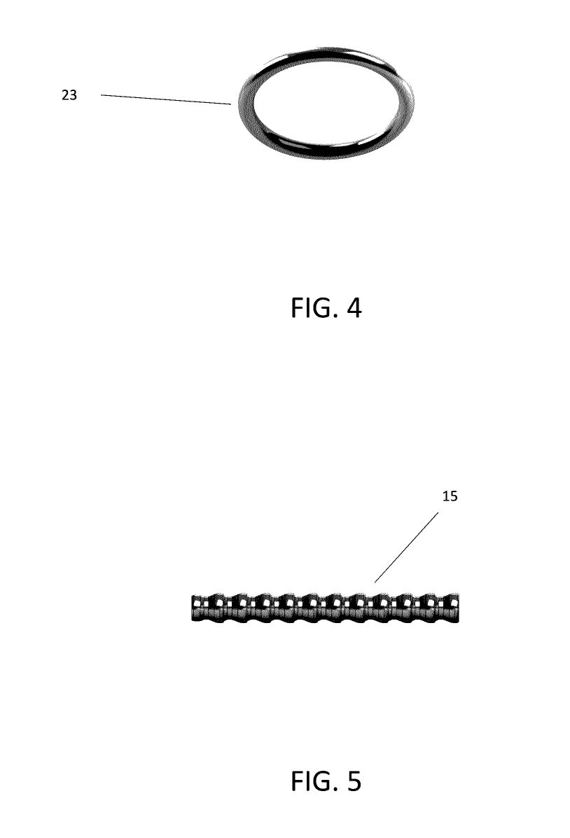

Included within the various openings mentioned are one or more seals 23, shown in FIG. 4. One or more seals may be used in openings such as the handle inlet 18, the handle outlet 19, the proximal and distal ends of the rod 13 and any other circular shaped opening where water flows through. The seal may be a rubber or plastic ring member used to prevent water leaks out of the attachment.

In use, the user first mates the water inlet of the handle 11 with the male end of a standard water hose. The user may then turn on the water source to allow the flow of water to the hose attachment 10. Once the user has engaged the trigger 12, the water is allowed to flow through the internal channel of the handle and out of the outlet 19 of the handle. The water then may flow through hollow rod or elongate tubular body 13, arm 15 and out of head/nozzle 16. The user may activate switch 21 to keep the internal valve within the handle open to allow water to continue to flow therethrough, or he may wish to continue to press down on the trigger without activating the switch. One hand may then be placed on the cushion 14 of the hose attachment while the other hand may be placed on the arm 15 to bend the arm in the desired position. The arm is configured to maintain that position without the need for the user to continue holding the arm or the need for an additional stiffening member. The water may then flow through the arm 15 and out nozzle or head 16 and spray members 27, 28 and 29 to achieve the desired spray pattern.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A watering hose attachment, comprising:
a) a handle having a water inlet located at a proximal end, a water outlet located at a distal end, and a water channel within the handle which connects the inlet and the outlet;
b) an articulating arm having a proximal end which is in connection with the water outlet and a distal end which is mated to a spray nozzle, the articulating arm comprising a first segment and a second segment, with each segment comprising:
a first hollow truncated sphere having an outer surface and an inner surface;
a second hollow truncated sphere having an outer surface and an inner surface;
a hollow, annular waist section having an outer surface and an inner surface
wherein the first and second hollow truncated spheres are joined together by the annular waist section with the outer surfaces of the first and second hollow truncated spheres merging with the outer surface of the hollow annular waist section and the inner surfaces of the first and second hollow truncated spheres merging with the inner surface of the hollow annular waist section
wherein the radius of curvature of the inner surface of the second hollow truncated sphere is slightly greater than the radius of curvature of the outer surface of the first hollow truncated sphere, such that the first hollow truncated sphere is partially contained within the second hollow truncated sphere.

2. The watering hose attachment of claim 1, further comprising an elongate tubular body having a proximal end and a distal end, wherein the elongate tubular body is mated to the water outlet of the handle at its proximal end and mated with the articulating arm at its distal end.

3. The watering hose attachment of claim 1, wherein the first hollow truncated sphere, the second hollow truncated sphere and the annular waist section form an hour glass configuration.

4. The watering hose attachment of claim 1, wherein wherein the first hollow truncated sphere, the second hollow truncated sphere and the annular waist section are formed as unitary one piece construction.

5. The watering hose attachment of claim 1, wherein the first and second segments are snap fitted together to form a fluid tight connection.

6. The watering hose attachment of claim 1, wherein the first and second segments are made out of a plastic material.

7. The watering hose attachment of claim 1, wherein the first and second segments form a hollow inner water passageway that is substantially free from obstructions.

8. The watering hose attachment of claim 7, wherein the articulating arm can be bent to direct the flow of water exiting the nozzle and maintain the bent position without the use of additional support.

9. The watering hose attachment of claim 1, wherein the articulating arm is substantially free from metal.

10. A watering hose attachment kit, comprising:
a) a handle having a water inlet located at a proximal end, a water outlet located at a distal end, and a water channel within the handle which connects the inlet and the outlet;
b) an articulating arm having a proximal end which is in connection with the water outlet and a distal end which is mated to a spray nozzle, the articulating arm comprising a first segment and a second segment, with each segment comprising:
a first hollow truncated sphere having an outer surface and an inner surface;
a second hollow truncated sphere having an outer surface and an inner surface;
a hollow, annular waist section having an outer surface and an inner surface
wherein the first and second hollow truncated spheres are joined together by the annular waist section with the outer surfaces of the first and second hollow truncated spheres merging with the outer surface of the hollow annular waist section and the inner surfaces of the first and second hollow truncated spheres merging with the inner surface of the hollow annular waist section
wherein the radius of curvature of the inner surface of the second hollow truncated sphere is slightly greater than the radius of curvature of the outer surface of the first hollow truncated sphere, such that the first hollow truncated sphere is partially contained within the second hollow truncated sphere
c) a third segment or a plurality of segments separated from the first and second segments which may be used to extend the length of the articulating arm.
